(19) United States
(12) Patent Application Publication
(10) Pub. No.: US 2026/0150871 A1
(43) Pub. Date: Jun. 4, 2026

(54) TASTE MODIFYING COMPOSITIONS AND USES THEREOF

(71) Applicant: Firmenich Incorporated, Plainsboro, NJ (US)

(72) Inventors: Robert WAGNER, Satigny (CH); Joseph R. FOTSING, San Diego, CA (US)

(73) Assignee: Firmenich Incorporated, Plainsboro, NJ (US)

(21) Appl. No.: 19/118,985

(22) PCT Filed: Oct. 23, 2023
(86) PCT No.: PCT/US2023/035722

§ 371 Date: Apr. 7, 2025

Related U.S. Application Data
(60) Provisional application No. 63/419,361, filed on Oct. 26, 2022.

(51) Int. Cl. A23L 27/26; A23L 27/00; A23L 27/20; A23L 27/22; A23L 27/23

(52) U.S. Cl. CPC A23L 27/26; A23L 27/204; A23L 27/22; A23L 27/23; A23L 27/88; A23V 2002/00

(57) ABSTRACT

The present disclosure generally relates to various formulations and uses of the compound: (E)-N-(4-cinnamamidobutyl)-4-hydroxy-2-methylbut-2-enamide, which is also referred to as (2E)-4-hydroxy-2-methyl-N-(4-{[(2E)-3-phenyl-2-propenoyl]amino}butyl)-2-butenamide, and which is referred to herein as “TM1,” or any comestibly acceptable salts thereof. In some aspects, the disclosure provides compositions that include TM1, or a comestibly acceptable salt thereof. In some embodiments, the compositions are ingestible compositions, including, but not limited to, packaged food or beverage products. In some other aspects, the disclosure provides uses of TM1, or a comestibly acceptable salt thereof, for enhancing an umami taste or a kokumi taste of an ingestible composition. In some other aspects, the disclosure provides uses of TM1, or a comestibly acceptable salt thereof, for enhancing sweetness of an ingestible composition. In some other aspects, the disclosure provides uses of TM1, or a comestibly acceptable salt thereof, for enhancing a meaty taste of an ingestible composition. In some embodiments of these aspects, TM1, or a comestibly acceptable salt thereof, is used in combination with one or more umami or kokumi tastants.

### TECHNICAL FIELD

The present disclosure generally relates to various formulations and uses of the compound: (E)-N-(4-cinnamamidobutyl)-4-hydroxy-2-methylbut-2-enamide, which is also referred to as (2E)-4-hydroxy-2-methyl-N-(4-{[(2E)-3-phenyl-2-propenoyl]amino}butyl)-2-butenamide, and which is referred to herein as “TM1,” or any comestibly acceptable salts thereof. In some aspects, the disclosure provides compositions that include TM1, or a comestibly acceptable salt thereof. In some embodiments, the compositions are ingestible compositions, including, but not limited to, packaged food or beverage products. In some other aspects, the disclosure provides uses of TM1, or a comestibly acceptable salt thereof, for enhancing an umami taste or a kokumi taste of an ingestible composition. In some other aspects, the disclosure provides uses of TM1, or a comestibly acceptable salt thereof, for enhancing sweetness of an ingestible composition. In some other aspects, the disclosure provides uses of TM1, or a comestibly acceptable salt thereof, for enhancing a meaty taste of an ingestible composition. In some embodiments of these aspects, TM1, or a comestibly acceptable salt thereof, is used in combination with one or more umami or kokumi tastants.

### DESCRIPTION OF RELATED ART

The taste system provides sensory information about the chemical composition of the external world. Taste transduction is one of the most sophisticated forms of chemical-triggered sensation in animals. Signaling of taste is found throughout the animal kingdom, from simple metazoans to the most complex of vertebrates. Mammals are believed to have five basic taste modalities: sweet, bitter, sour, salty, and umami.

Umami is the taste most commonly associated with the savory taste of monosodium glutamate (MSG), meat products, cheeses, tomatoes, mushrooms, soy sauce, fish sauce, miso, and the like. Mammals generally perceive umami to be a pleasurable sensation. Kokumi is a related taste commonly associated with the taste of fermented products, soy sauce, fish sauce, and shrimp paste. Many of these typical sources of umami and kokumi taste are high in glutamic acid and salt, or rely on animal products.

Excessive sodium intake can cause a number of health-related problems. One such problem is hypertension. Hypertension is a condition in which the pressure of the blood against artery walls is high enough that it may eventually cause heart disease and other health problems. Excessive sodium intake also adversely affect the balance of water and minerals in the body. For example, excessive sodium intake can cause calcium loss, which can lead to osteoporosis and other problems. Excessive consumption of food products containing glutamic acid can also have certain adverse health effects, as glutamic acid interferes with the functioning of neurotransmitters. Thus, it is generally desirable to reduce the consumption of sodium and glutamic acid. Further, there is increased consumer demand for food and beverage products that do not contain animal-derived ingredients, such as animal-derived fats, meat products, or dairy products.

Enhancement of salt, umami, or kokumi flavors provides an alternative approach to partially or completely replacing ingredients that are traditionally used to impart salt, umami, and/or kokumi taste. Even so, there is a limited number of compounds, especially naturally derived compounds, that can accomplish this effectively. Thus, there is a continuing need to discover new compounds having utility as flavor modifiers, especially compounds that enhance, among other flavors, the taste of salt, umami, kokumi, or any combination thereof.

### SUMMARY

The present disclosure generally relates to various formulations and uses of (E)-N-(4-cinnamamidobutyl)-4-hydroxy-2-methylbut-2-enamide, which is also referred to herein as “TM1” or any comestibly acceptable salts thereof (E)-N-(4-Cinnamamidobutyl)-4-hydroxy-2-methylbut-2-enamide, which is also referred to herein as “TM1” and which is represented by the chemical structure

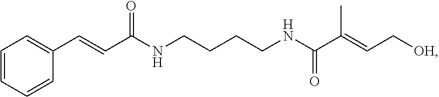 [SMILES: C/C(=C\CO)C(=O)NCCCCNC(=O)/C=C/c1ccccc1]

and comestibly acceptable salts thereof, can impart certain beneficial taste properties when used in combination with certain umami tastants, thereby allowing one to use less of those tastants in food and beverage products.

In a first aspect, the disclosure provides an ingestible composition comprising TM1 or a comestibly acceptable salt thereof. In some embodiments, the ingestible composition comprises one or more umami tastants, kokumi tastants, bitter tastants, sweeteners, salty tastants, and the like. In some embodiments, the ingestible composition comprises a plant protein, such as pea protein, soy protein, or a combination thereof.

In a second aspect, the disclosure provides uses of TM1 or a comestibly acceptable salt thereof to enhance an umami taste of an ingestible composition. In a related aspect, the disclosure provides methods of enhancing an umami taste of an ingestible composition, the method comprising introducing TM1 or a comestibly acceptable salt thereof to the ingestible composition. In some embodiments of the foregoing aspects, the ingestible composition comprises an umami tastant, such as glutamates, arginates, purine ribonucleotides (for example, inosine monophosphate (IMP), guanosine monophosphate (GMP), hypoxanthine, inosine, or any combination thereof), yeast extracts, or any combination thereof. In some embodiments, the ingestible composition comprises a plant protein, such as pea protein, soy protein, or a combination thereof. In some embodiments, the use or introduction enhances an umami taste without enhancing a salty taste of the ingestible composition.

In a third aspect, the disclosure provides uses of TM1 or a comestibly acceptable salt thereof to reduce an amount of an umami tastant in an ingestible composition. In a related aspect, the disclosure provides methods of reducing an amount of an umami tastant in an ingestible composition, the method comprising introducing TM1 or a comestibly acceptable salt thereof to the ingestible composition. In some embodiments, the umami tastant is a glutamate, such as monosodium glutamate (MSG). In some embodiments, the ingestible comprises other umami tastants, such as purine ribonucleotides (for example, inosine monophosphate (IMP), guanosine monophosphate (GMP), hypoxanthine, inosine, or any combination thereof), yeast extracts, or any combination thereof. In some embodiments, the ingestible composition comprises a plant protein, such as pea protein, soy protein, or a combination thereof.

In a fourth aspect, the disclosure provides uses of TM1 or a comestibly acceptable salt thereof to enhance a kokumi taste of an ingestible composition. In a related aspect, the disclosure provides methods of enhancing a kokumi taste of an ingestible composition, the method comprising introducing TM1 or a comestibly acceptable salt thereof to the ingestible composition. In some embodiments of the foregoing aspects, the ingestible composition comprises a kokumi tastant, such as yeast extracts, fermented food products, cheeses, garlic or extracts thereof, gamma-glutamyl-containing polypeptides, a gamma-glutamyl-containing oligopeptides (such as gamma-glutamyl-containing tripeptides), amide compounds (such as cinnamic acid amides or a derivative thereof), nucleotides, oligonucleotides, plant extracts, food extracts, or any combination thereof. In some embodiments, the ingestible composition comprises a plant protein, such as pea protein, soy protein, or a combination thereof.

In a fifth aspect, the disclosure provides uses of TM1 or a comestibly acceptable salt thereof to enhance a sweet taste of an ingestible composition. In a related aspect, the disclosure provides methods of enhancing a sweet taste of an ingestible composition, the method comprising introducing TM1 or a comestibly acceptable salt thereof to the ingestible composition. In some embodiments of the foregoing aspects, the ingestible composition comprises a sweetener, such as sucrose, fructose, glucose, lactose, sugar alcohols, or high-intensity sweeteners, such as steviol glycosides, mogrosides, sucralose, aspartame, neotame, acesulfame potassium, and the like. In some embodiments, the ingestible composition comprises a plant protein, such as pea protein, soy protein, or a combination thereof.

In a sixth aspect, the disclosure provides uses of TM1 or a comestibly acceptable salt thereof to enhance a perceived juiciness of an ingestible composition. In a related aspect, the disclosure provides methods of enhancing a perceived juiciness of an ingestible composition, the method comprising introducing TM1 or a comestibly acceptable salt thereof to the ingestible composition. In some embodiments, the ingestible composition comprises a plant protein, such as pea protein, soy protein, or a combination thereof.

In a seventh aspect, the disclosure provides uses of TM1 or a comestibly acceptable salt thereof to enhance a meaty taste of an ingestible composition. In a related aspect, the disclosure provides methods of enhancing a meaty taste of an ingestible composition, the method comprising introducing TM1 or a comestibly acceptable salt thereof to the ingestible composition. In some embodiments, the ingestible composition comprises a meat flavoring, such as a chicken flavoring, a turkey flavoring, a beef flavoring, a pork flavoring, and the like. In some embodiments, the meaty taste is a chicken taste, a turkey taste, a beef taste, a pork taste, or the like. In some embodiments, the ingestible composition comprises a plant protein, such as pea protein, soy protein, or a combination thereof.

In an eighth aspect, the disclosure provides uses of TM1 or a comestibly acceptable salt thereof to reduce (or eliminate) an amount of animal products in an ingestible composition. In a related aspect, the disclosure provides methods of reducing (or eliminating) an amount of animal products in an ingestible composition, the method comprising introducing TM1 or a comestibly acceptable salt thereof to the ingestible composition. In some embodiments, the ingestible composition comprises a meat flavoring, such as a chicken flavoring, a turkey flavoring, a beef flavoring, a pork flavoring, and the like. In some embodiments, the ingestible composition comprises a plant protein, such as pea protein, soy protein, or a combination thereof.

In a ninth aspect, the disclosure provides uses of TM1 or a comestibly acceptable salt thereof to enhance a vegetal taste of an ingestible composition. In a related aspect, the disclosure provides methods of enhancing a vegetal taste of an ingestible composition, the method comprising introducing TM1 or a comestibly acceptable salt thereof to the ingestible composition. In some embodiments, the ingestible composition comprises a vegetal flavoring. In some embodiments, the ingestible composition comprises a plant protein, such as pea protein, soy protein, or a combination thereof.

In a tenth aspect, the disclosure provides uses of TM1 or a comestibly acceptable salt thereof to enhance a sour taste of an ingestible composition. In a related aspect, the disclosure provides methods of enhancing a sour taste of an ingestible composition, the method comprising introducing TM1 or a comestibly acceptable salt thereof to the ingestible composition. In some embodiments, the ingestible composition comprises a sour tastant, such as acetic acid, lactic acid, malonic acid, malic acid, ascorbic acid, citric acid, and the like. In some embodiments, the ingestible composition comprises a plant protein, such as pea protein, soy protein, or a combination thereof.

In an eleventh aspect, the disclosure provides uses of TM1 or a comestibly acceptable salt thereof to enhance a perceived fattiness of an ingestible composition. In a related aspect, the disclosure provides methods of enhancing a perceived fattiness of an ingestible composition, the method comprising introducing TM1 or a comestibly acceptable salt thereof to the ingestible composition. In some embodiments, the ingestible composition comprises a plant protein, such as pea protein, soy protein, or a combination thereof.

In a twelfth aspect, the disclosure provides uses of TM1 or a comestibly acceptable salt thereof to enhance a perceived ethanol content of an ingestible composition. In a related aspect, the disclosure provides methods of enhancing a perceived ethanol content of an ingestible composition, the method comprising introducing TM1 or a comestibly acceptable salt thereof to the ingestible composition. In some embodiments, the ingestible composition is a beverage and comprises ethanol, for example, at a concentration no greater than 5 percent by volume, or no greater than 4 percent by volume, or no greater than 3 percent by volume, or no greater than 2 percent by volume.

In a thirteenth aspect, the disclosure provides a flavored product comprising an ingestible composition of the first aspect, or any of the ingestible compositions formed by the use or method of the second through twelfth aspects. In some embodiments, the flavored product is a food product, such as a soup, a packaged casserole mix, a meat analogue product, such as a vegan chicken nugget or tender, a vegan chicken filet, a vegan burger, a vegan beef cutlet, and the like. In some other embodiments, the ingestible composition is a beverage product, such as a carbonated beverage, a dairy analogue product, a hard seltzer, and the like.

Further aspects, and embodiments thereof, are set forth below in the Detailed Description, the Drawings, the Abstract, and the Claims.

### BRIEF DESCRIPTION OF THE DRAWINGS

The drawings are provided for illustrative purposes only, and are not intended to describe any preferred compositions or preferred methods, or to serve as a source of any limitations on the scope of the claimed inventions.

FIG. 1 shows a chemical formula that represents the compound (2E)-4-hydroxy-2-methyl-N-(4-{[(2E)-3-phenyl-2-propenoyl]amino}butyl)-2-butenamide.

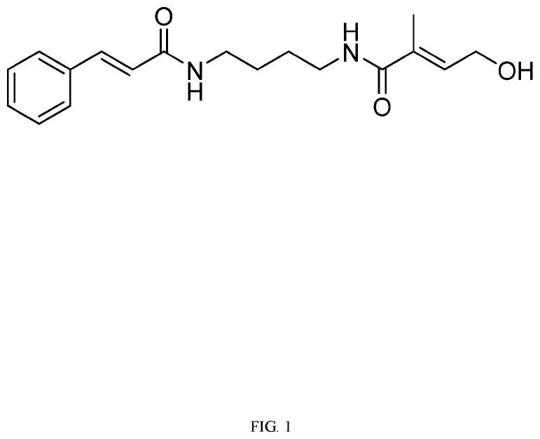

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary The terms a “sweetener” or a “sweet flavoring agent” or a “sweet flavor entity” or a “sweet compound” or a “sweet tastant” herein refers to a compound that elicits a detectable sweet flavor in a subject. e.g., a compound that activates a T1R2/T1R3 taste receptor in vitro.

The terms a “bitter compound” or a “bitter tastant” herein refers to a compound that elicits a detectable bitter flavor in a subject, e.g., a compound that activates one or more T2R taste receptor in vitro.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include.” “have,” and ‘composed of’ and their grammatical variants have the same meaning. In contrast. “consist of” or “consists of” or “consisting of” refer to groups that are closed. For example, the phrase “consists of A” means that A and only A is present.

As used herein. “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A can be present and not B, or that B is present and not A. or that A and B are both present.

Further, if A, for example, defines a class that can have multiple members, e.g., A₁ and A₂, then one or more members of the class can be present concurrently.

Chemical structures are often shown using the “skeletal” format, such that carbon atoms are not explicitly shown, and hydrogen atoms attached to carbon atoms are omitted entirely. For example, the structure

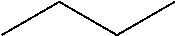

represents butane (i.e., n-butane). Furthermore, aromatic groups, such as benzene, are represented by showing one of the contributing resonance structures. For example, the structure

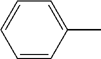

represents toluene.

Other terms are defined in other portions of this description, even though not included in this subsection.

### Flavor-Modifying Compounds

The present disclosure provides compositions, uses, and methods relating to the compound (2E)-4-hydroxy-2-methyl-N-(4-{[(2E)-3-phenyl-2-propenoyl]amino}butyl)-2-butenamide:

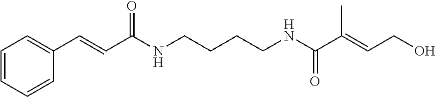 [SMILES: C/C(=C\CO)C(=O)NCCCCNC(=O)/C=C/c1ccccc1]

or comestibly acceptable salts thereof. The compound of the above formula is also described herein as (E)-N-(4-cinnamamidobutyl)-4-hydroxy-2-methylbut-2-enamide, or by the abbreviation “TM1”.

The skilled artisan will recognize that some structures described herein may be resonance forms or tautomers of compounds that may be fairly represented by other chemical structures, even when kinetically; the artisan recognizes that such structures may only represent a very small portion of a sample of such compound(s). Such compounds are considered within the scope of the structures depicted, though such resonance forms or tautomers are not represented herein.

Isotopes may be present in the compounds described. Each chemical element as represented in a compound structure may include any isotope of said element. For example, in a compound structure a hydrogen atom may be explicitly disclosed or understood to be present in the compound. At any position of the compound that a hydrogen atom may be present, the hydrogen atom can be any isotope of hydrogen, including but not limited to hydrogen-1 (protium) and hydrogen-2 (deuterium). Thus, reference herein to a compound encompasses all potential isotopic forms unless the context clearly dictates otherwise.

In some embodiments, the TM1 is capable of forming acid or base salts by virtue of the presence of amino or carboxyl groups or groups similar thereto. Comestibly acceptable acid addition salts can be formed with inorganic acids and organic acids. Inorganic acids from which salts can be derived include, for example, hydrochloric acid, hydrobromic acid, sulfuric acid, nitric acid, phosphoric acid, and the like. Organic acids from which salts can be derived include, for example, acetic acid, propionic acid, glycolic acid, pyruvic acid, oxalic acid, maleic acid, malonic acid, succinic acid, fumaric acid, tartaric acid, citric acid, benzoic acid, cinnamic acid, mandelic acid, methanesulfonic acid, ethanesulfonic acid, p-toluenesulfonic acid, salicylic acid, and the like. Physiologically acceptable salts can be formed using inorganic and organic bases. Inorganic bases from which salts can be derived include, for example, bases that contain sodium, potassium, lithium, ammonium, calcium, magnesium, iron, zinc, copper, manganese, aluminum, and the like; particularly preferred are the ammonium, potassium, sodium, calcium and magnesium salts. In some embodiments, treatment of the compounds disclosed herein with an inorganic base results in loss of a labile hydrogen from the compound to afford the salt form including an inorganic cation such as Li⁺, Na⁺, K⁺, Mg²⁺ and Ca²⁺ and the like. Organic bases from which salts can be derived include, for example, primary, secondary, and tertiary amines, substituted amines including naturally occurring substituted amines, cyclic amines, basic ion exchange resins, and the like, specifically such as isopropylamine, trimethylamine, diethylamine, triethylamine, tripropylamine, and ethanolamine.

In the aspects and embodiments set forth herein, TM1 or its cometibly acceptable salts can be in any suitable solid-state form or solubilized form. In some embodiments, TM1 or any of its comestibly acceptable salts exists as a crystalline solid, either in substantially pure form or in a formulation such as those set forth below. The crystalline solid can have any suitable polymorphic form, such as any polymorphic form obtainable via recrystallization in any suitable solvent system, according to techniques commonly used in the art of polymorph screening. In some other embodiments, TM1 or any of its comestibly acceptable salts exists as an amorphous solid or a semi-amorphous solid, meaning that it lacks any regular crystalline structure. Such solids can be generated using standard techniques, such as spray drying, and the like.

In some embodiments, TM1 or any or its comestibly acceptable salts exists as a solvate, which is a pseudomorphic form of the compound in which one or more solvent molecules (such as water molecules) are taken up into the crystalline structure. Any suitable solvent or combination of solvents can be used, including, but not limited to, water, methanol, ethanol, n-propanol, isopropanol, n-butanol, 2-butanol, isobutanol, ethyl acetate, ethylene glycol, 1,2-propylene glycol, 1,3-propylene glycol, and the like. In some embodiments, the disclosure provides hydrates of the TM1 compound or its comestibly acceptable salts. Such solvates can be generated by any suitable means, such as those techniques typically used by skilled artisans in the field of polymorph and solvate screening.

In some other embodiments, the TM1 compound or any of its comestibly acceptable salts exist as a co-crystal with one or more other compounds, such as one or more other umami tastants.

In some embodiments, TM1 or its comestibly acceptable salts is in the form of a dry particle. Such dry particles can be formed by standard techniques in the art, such as dry granulation, wet granulation, and the like. Such particles can also contain a number of excipients, including, inert diluents, such as calcium carbonate, sodium carbonate, lactose, calcium phosphate, and sodium phosphate; granulating and disintegrating agents, such as starch, cellulosic materials, and alginic acid; binding agents, such as gelatin, guar gum, and acacia; and lubricating agents, such as magnesium stearate, stearic acid, and talc. Other excipients typically used in food and beverage products can also be included, such as typical foodstuff materials.

In some embodiments, TM1 or its comestibly acceptable salts are in the form of a liquid solution or a liquid suspension. Such compositions can also include: carboxymethylcellulose, methylcellulose, hydroxypropylmethylcellulose, sodium alginate, polyvinylpyrrolidone, gum tragacanth and gum acacia; dispersing or wetting agents may be a naturally-occurring phosphatide such as lecithin, or condensation products of an alkylene oxide with fatty acids, for example polyoxyethylene stearate, or condensation products of ethylene oxide with long chain aliphatic alcohols, for example, heptadecaethyl-eneoxycetanol, or condensation products of ethylene oxide with partial esters derived from fatty acids and a hexitol such as polyoxyethylene sorbitol monooleate, or condensation products of ethylene oxide with partial esters derived from fatty acids and hexitol anhydrides, for example polyethylene sorbitan monooleate. Such compositions can also include one or more coloring agents, one or more flavoring agents, and the like. Such liquid suspensions and solutions have a liquid carrier. In general, the liquid carrier comprises water. In some such cases, the liquid composition is an emulsion, such as an oil-in-water or a water-in-oil emulsion. Further, in some cases, water may be too polar to dissolve the TM1 compound to the desired concentration. In such instances, it can be desirable to introduce water-miscible solvents, such as alcohols, glycols, polyols, and the like, to the solvent to enhance solubilization of TM1.

In some embodiments, TM1, or its comestibly acceptable salts, is in the form of a solution, i.e., are solvated within a liquid carrier. In some embodiments, the liquid carrier is an aqueous carrier. In some such embodiments, the solutions comprise a comestibly acceptable salt of TM1, such as a hydrochloride sale, a potassium salt, or a sodium salt. Such solutions can be diluted to any suitable concentration.

### Formulations, Uses, and Methods

In certain aspects, the disclosure provides an ingestible composition comprising TM1 or a comestibly acceptable salt thereof. In some embodiments, the ingestible composition comprises an umami tastant. Such umami tastants include, but are not limited to, N-(heptan-4-yl)benzo[d][1,3]dioxole-5-carboxamide, N¹-(2,4-dimethoxybenzyl)-N²-(2-(pyridin-2-yl)ethyl)oxalamide, N-3,7-dimethyl-2,6-octaduenylcyclopropylcarboxmide, (E)-3-(3,4-dimethoxyphenyl)-N-(4-methoxyphenethyl)acrylamide, N¹-(2-methoxy-4-methylbenzyl)-N²-(2-(4-methylpyridin-2-yl)ethyl)oxalamide, N¹-(2-methoxy-4-methylbenzyl)-N²-(2-(pyridin-2-yl)ethyl)oxalamide, N¹-(2,3-dimethoxybenzyl)-N²-(2-(pyridin-2-yl)ethyl)oxalamide, (R)-N-(1-methoxy-4-methylpentan-2-yl)-3,4-dimethylbenzamide, 2-(((3-(2,3-dimethoxyphenyl)-1H-1,2,4-triazol-5-yl)thio)methyl)-pyridine, 2-(((5-(2,4-dimethylphenyl)-1H-1,2,4-triazol-3-yl)thio)methyl)pyridine, N-((3S,3aR,6S,6aR)-6-(4-cyclohexylbutanamido)hexahydrofuro[3,2-b]furan-3-yl)-cyclopropanecarboxamide, alkyl amides, glutamates (such as monosodium glutamate (MSG)), arginates, purinic ribotides (such as inosine monophosphate (IMP), adenosine monophosphate (AMP), guanosine monophosphate (GMP), and sodium salts thereof), amino acids (such as L-threanine, L-methionine, L-cysteine, and L-tauring), yeast extracts, diketopiperazines and other Maillard reaction products, and alcohol. In some embodiments, the ingestible composition is free of monosodium glutamate. In some embodiments, the ingestible composition comprises no more than 0.05 percent by weight, or no more than 0.04 percent by weight, or no more than 0.03 percent by weight, or no more than 0.02 percent by weight, or no more than 0.01 percent by weight, monosodium glutamate, based on the total weight of the ingestible composition. In some embodiments, the ingestible composition comprises inosine monophosphate (IMP), guanosine monophosphate (GMP), or a combination thereof. In some embodiments, the ingestible composition comprises a yeast extract. In some embodiments, the ingestible composition comprises a kokumi tastant, such as a yeast extract, a fermented food product, a cheese, garlic or an extract thereof, a gamma-glutamyl-containing polypeptide, a gamma-glutamyl-containing oligopeptide (such as a gamma-glutamyl-containing tripeptide), a cinnamic acid amide or a derivative thereof, a nucleotide, an oligonucleotide, a plant extract, a food extract, or any combination thereof. In some embodiments, the ingestible composition comprises a salty tastant, such as sodium chloride.

In certain aspects, the disclosure provides uses of TM1 or a comestibly acceptable salt thereof to enhance an umami taste of an ingestible composition. In a related aspect, the disclosure provides methods of enhancing an umami taste of an ingestible composition, the method comprising introducing TM1 or a comestibly acceptable salt thereof to the ingestible composition. In some embodiments, the ingestible composition comprises an umami tastant. Such umami tastants include, but are not limited to, N-(heptan-4-yl)benzo[d][1,3]dioxole-5-carboxamide, N¹-(2,4-dimethoxybenzyl)-N²-(2-(pyridin-2-yl)ethyl)oxalamide, alkyl amides, glutamates (such as monosodium glutamate (MSG)), arginates, purinic ribotides (such as inosine monophosphate (IMP), adenosine monophosphate (AMP), guanosine monophosphate (GMP), and sodium salts thereof), amino acids (such as L-threanine), yeast extracts, and alcohol. In some embodiments, the ingestible composition comprises no more than 0.05 percent by weight, or no more than 0.04 percent by weight, or no more than 0.03 percent by weight, or no more than 0.02 percent by weight, or no more than 0.01 percent by weight, monosodium glutamate, based on the total weight of the ingestible composition. In some embodiments, the ingestible composition comprises inosine monophosphate (IMP), guanosine monophosphate (GMP), or a combination thereof. In some embodiments, the ingestible composition comprises a yeast extract. In some embodiments, the ingestible composition comprises a kokumi tastant, such as a yeast extract, a fermented food product, a cheese, garlic or an extract thereof, a gamma-glutamyl-containing polypeptide, a gamma-glutamyl-containing oligopeptide (such as a gamma-glutamyl-containing tripeptide), a cinnamic acid amide or a derivative thereof, a nucleotide, an oligonucleotide, a plant extract, a food extract, or any combination thereof. In some embodiments, the ingestible composition comprises a salty tastant, such as sodium chloride. In some embodiments, the use or method enhances an umami taste without enhancing a salty taste.

In certain aspects, the disclosure provides uses of TM1 or a comestibly acceptable salt thereof to reduce an amount of an umami tastant in an ingestible composition. In a related aspect, the disclosure provides methods of reducing an amount of an umami tastant in an ingestible composition, the method comprising introducing TM1 or a comestibly acceptable salt thereof to the ingestible composition. In some embodiments, the umami tastant is a glutamate, such as monosodium glutamate (MSG). In some embodiments, reducing an amount of MSG comprises reducing an amount of MSG by at least 10%, or at least 20%, or at least 30%, or at least 40%, or at least 50%, or at least 60%, or at least 70%, or at least 80%, to achieve a comparable umami taste compared to an ingestible composition lacking TM1 or its comestibly acceptable salts. In some embodiments, the ingestible comprises other umami tastants, such as purine ribonucleotides (for example, inosine monophosphate (IMP), guanosine monophosphate (GMP), hypoxanthine, inosine, or any combination thereof), yeast extracts, or any combination thereof. In some embodiments, the ingestible composition comprises a plant protein, such as pea protein, soy protein, or a combination thereof.

In certain aspects, the disclosure provides uses of TM1 or a comestibly acceptable salt thereof to enhance a kokumi taste of an ingestible composition. In a related aspect, the disclosure provides methods of enhancing a kokumi taste of an ingestible composition, the method comprising introducing TM1 or a comestibly acceptable salt thereof to the ingestible composition. In some embodiments of the foregoing aspects, the ingestible composition comprises a kokumi tastant, such as yeast extracts, fermented food products, cheeses, garlic or extracts thereof, gamma-glutamyl-containing polypeptides, a gamma-glutamyl-containing oligopeptides (such as gamma-glutamyl-containing tripeptides), amide compounds (such as cinnamic acid amides or a derivatives thereof), nucleotides, oligonucleotides, plant extracts, food extracts, or any combination thereof. In some embodiments, the ingestible composition comprises an umami tastant, such as glutamates, arginates, purine ribonucleotides (for example, inosine monophosphate (IMP), guanosine monophosphate (GMP), hypoxanthine, inosine, or any combination thereof), or any combination thereof. In some embodiments, the ingestible composition comprises inosine monophosphate (IMP), guanosine monophosphate (GMP), or a combination thereof. In some embodiments, the ingestible composition comprises a yeast extract. In some embodiments, the ingestible composition comprises a plant protein, such as pea protein, soy protein, or a combination thereof.

In certain aspects, the disclosure provides uses of TM1 or a comestibly acceptable salt thereof to enhance a sweet taste of an ingestible composition. In a related aspect, the disclosure provides methods of enhancing a sweet taste of an ingestible composition, the method comprising introducing TM1 or a comestibly acceptable salt thereof to the ingestible composition. In some embodiments of the foregoing aspects, the ingestible composition comprises a sweetener, such as sucrose, fructose, glucose, lactose, sugar alcohols, or high-intensity sweeteners, such as steviol glycosides, mogrosides, sucralose, aspartame, neotame, acesulfame potassium, and the like. In some embodiments, the ingestible composition comprises an umami tastant, such as glutamates, arginates, purine ribonucleotides (for example, inosine monophosphate (IMP), guanosine monophosphate (GMP), hypoxanthine, inosine, or any combination thereof), yeast extracts, or any combination thereof. In some embodiments, the ingestible composition comprises inosine monophosphate (IMP), guanosine monophosphate (GMP), or a combination thereof. In some embodiments, the ingestible composition comprises a yeast extract. In some embodiments, the ingestible composition comprises a plant protein, such as pea protein, soy protein, or a combination thereof.

In certain aspects, the disclosure provides uses of TM1 or a comestibly acceptable salt thereof to enhance a perceived juiciness of an ingestible composition. In a related aspect, the disclosure provides methods of enhancing a perceived juiciness of an ingestible composition, the method comprising introducing TM1 or a comestibly acceptable salt thereof to the ingestible composition. In some embodiments, the ingestible composition comprises an umami tastant, such as glutamates, arginates, purine ribonucleotides (for example, inosine monophosphate (IMP), guanosine monophosphate (GMP), hypoxanthine, inosine, or any combination thereof), yeast extracts, or any combination thereof. In some embodiments, the ingestible composition comprises inosine monophosphate (IMP), guanosine monophosphate (GMP), or a combination thereof. In some embodiments, the ingestible composition comprises a yeast extract. In some embodiments, the ingestible composition comprises a plant protein, such as pea protein, soy protein, or a combination thereof.

In certain aspects, the disclosure provides uses of TM1 or a comestibly acceptable salt thereof to enhance a meaty taste of an ingestible composition. In a related aspect, the disclosure provides methods of enhancing a meaty taste of an ingestible composition, the method comprising introducing TM1 or a comestibly acceptable salt thereof to the ingestible composition. In some embodiments, the ingestible composition comprises a meat flavoring, such as a chicken flavoring, a turkey flavoring, a beef flavoring, a pork flavoring, and the like. In some embodiments, the meaty taste is a chicken taste, a turkey taste, a beef taste, a pork taste, or the like. In some embodiments, the ingestible composition comprises an umami tastant, such as glutamates, arginates, purine ribonucleotides (for example, inosine monophosphate (IMP), guanosine monophosphate (GMP), hypoxanthine, inosine, or any combination thereof), yeast extracts, or any combination thereof. In some embodiments, the ingestible composition comprises inosine monophosphate (IMP), guanosine monophosphate (GMP), or a combination thereof. In some embodiments, the ingestible composition comprises a yeast extract. In some embodiments, the ingestible composition comprises a plant protein, such as pea protein, soy protein, or a combination thereof.

In certain aspects, the disclosure provides uses of TM1 or a comestibly acceptable salt thereof to reduce (or eliminate) an amount of animal products in an ingestible composition. In a related aspect, the disclosure provides methods of reducing (or eliminating) an amount of animal products in an ingestible composition, the method comprising introducing TM1 or a comestibly acceptable salt thereof to the ingestible composition. In some embodiments, the ingestible composition comprises no animal products. In some embodiments, the ingestible composition comprises a meat flavoring, such as a chicken flavoring, a turkey flavoring, a beef flavoring, a pork flavoring, and the like. In some embodiments, the ingestible composition comprises an umami tastant, such as glutamates, arginates, purine ribonucleotides (for example, inosine monophosphate (IMP), guanosine monophosphate (GMP), hypoxanthine, inosine, or any combination thereof), yeast extracts, or any combination thereof. In some embodiments, the ingestible composition comprises inosine monophosphate (IMP), guanosine monophosphate (GMP), or a combination thereof. In some embodiments, the ingestible composition comprises a yeast extract. In some embodiments, the ingestible composition comprises a plant protein, such as pea protein, soy protein, or a combination thereof.

In certain aspects, the disclosure provides uses of TM1 or a comestibly acceptable salt thereof to enhance a vegetal taste of an ingestible composition. In a related aspect, the disclosure provides methods of enhancing a vegetal taste of an ingestible composition, the method comprising introducing TM1 or a comestibly acceptable salt thereof to the ingestible composition. In some embodiments, the ingestible composition comprises a vegetal flavoring, such as a tomato flavoring, a celery flavoring, and the like. In some embodiments, the ingestible composition comprises an umami tastant, such as glutamates, arginates, purine ribonucleotides (for example, inosine monophosphate (IMP), guanosine monophosphate (GMP), hypoxanthine, inosine, or any combination thereof), yeast extracts, or any combination thereof. In some embodiments, the ingestible composition comprises inosine monophosphate (IMP), guanosine monophosphate (GMP), or a combination thereof. In some embodiments, the ingestible composition comprises a yeast extract. In some embodiments, the ingestible composition comprises a plant protein, such as pea protein, soy protein, or a combination thereof.

In certain aspects, the disclosure provides uses of TM1 or a comestibly acceptable salt thereof to enhance a sour taste of an ingestible composition. In a related aspect, the disclosure provides methods of enhancing a sour taste of an ingestible composition, the method comprising introducing TM1 or a comestibly acceptable salt thereof to the ingestible composition. In some embodiments, the ingestible composition comprises a sour tastant, such as acetic acid, lactic acid, malonic acid, malic acid, ascorbic acid, citric acid, and the like. In some embodiments, the ingestible composition comprises an umami tastant, such as glutamates, arginates, purine ribonucleotides (for example, inosine monophosphate (IMP), guanosine monophosphate (GMP), hypoxanthine, inosine, or any combination thereof), yeast extracts, or any combination thereof. In some embodiments, the ingestible composition comprises inosine monophosphate (IMP), guanosine monophosphate (GMP), or a combination thereof. In some embodiments, the ingestible composition comprises a yeast extract. In some embodiments, the ingestible composition comprises a plant protein, such as pea protein, soy protein, or a combination thereof.

In certain aspects, the disclosure provides uses of TM1 or a comestibly acceptable salt thereof to enhance a perceived fattiness of an ingestible composition. In a related aspect, the disclosure provides methods of enhancing a perceived fattiness of an ingestible composition, the method comprising introducing TM1 or a comestibly acceptable salt thereof to the ingestible composition. In some embodiments, the ingestible composition comprises an umami tastant, such as glutamates, arginates, purine ribonucleotides (for example, inosine monophosphate (IMP), guanosine monophosphate (GMP), hypoxanthine, inosine, or any combination thereof), yeast extracts, or any combination thereof. In some embodiments, the ingestible composition comprises inosine monophosphate (IMP), guanosine monophosphate (GMP), or a combination thereof. In some embodiments, the ingestible composition comprises a yeast extract. In some embodiments, the ingestible composition comprises a plant protein, such as pea protein, soy protein, or a combination thereof.

In certain aspects, the disclosure provides uses of TM1 or a comestibly acceptable salt thereof to enhance a perceived ethanol content of an ingestible composition. In a related aspect, the disclosure provides methods of enhancing a perceived ethanol content of an ingestible composition, the method comprising introducing TM1 or a comestibly acceptable salt thereof to the ingestible composition. In some embodiments, the ingestible composition is a beverage and comprises ethanol, for example, at a concentration no greater than 5 percent by volume, or no greater than 4 percent by volume, or no greater than 3 percent by volume, or no greater than 2 percent by volume. In some embodiments, the ingestible composition comprises a flavoring, such as a fruit flavoring, a tea flavoring, and the like.

In the foregoing aspects, TM1 or a comestibly acceptable salt thereof can be included in, used in, or introduced to the ingestible composition in any suitable concentration. For example, in some embodiments, the ingestible composition comprises TM1 or a comestibly acceptable salt thereof at a concentration ranging from 0.1 ppm to 500 ppm, or from 0.1 ppm to 400 ppm, or from 0.1 ppm to 300 ppm, or from 0.1 ppm to 200 ppm, or from 0.1 ppm to 100 ppm, or from 0.1 ppm to 50 ppm, or from 0.1 ppm to 25 ppm, or from 0.1 ppm to 10 ppm, or from 0.1 ppm to 7 ppm, or from 0.1 ppm to 5 ppm, or from 0.5 ppm to 500 ppm, or from 0.5 ppm to 400 ppm, or from 0.5 ppm to 300 ppm, or from 0.5 ppm to 200 ppm, or from 0.5 ppm to 100 ppm, or from 0.5 ppm to 50 ppm, or from 0.5 ppm to 25 ppm, or from 0.5 ppm to 10 ppm, or from 0.5 ppm to 7 ppm, or from 0.5 ppm to 5 ppm, or from 1 ppm to 500 ppm, or from 1 ppm to 400 ppm, or from 1 ppm to 300 ppm, or from 1 ppm to 200 ppm, or from 1 ppm to 100 ppm, or from 1 ppm to 50 ppm, or from 1 ppm to 25 ppm, or from 1 ppm to 10 ppt, or from 1 ppm to 7 ppm, or from 1 ppm to 5 ppm. Such ingestible compositions can be in any suitable form. In some embodiments, the ingestible composition is a food product, such as any of those specifically listed below. In other embodiments, the ingestible composition is a beverage product, such as a soda, and the like. In other embodiments, the ingestible composition is an oral care product, such as toothpaste, mouthwash, whitening composition, and the like. In other embodiments, the ingestible composition is a nutraceutical product. In other embodiments, the ingestible composition is a pharmaceutical product, such as an OTC or prescription drug product.

In certain embodiments, the ingestible composition comprises animal products (such as animal proteins, which can be replaced by starches, fibers, or proteins derived from plants, algae, or fungi), and TM1 or comestibly acceptable salts thereof. In some such embodiments, the introduction of the TM1 compound (or comestibly acceptable salt thereof) permits one to use less animal product (such as more than 10% less, more than 20% less, more than 30% less, more than 40% less, more than 50% less, more than 60% less, or more than 70% less, or more than 80% less, or more than 90% less) and still achieve a taste characteristic of a comparable product that employs a higher concentration of animal products. In some related embodiments, the use of the TM1 compound, or its comestibly acceptable salts, permits the elimination of animal products from the composition. Such ingestible compositions can be in any suitable form. In some embodiments, the ingestible composition is a food product, such as any of those specifically listed below. In other embodiments, the ingestible composition is a beverage product, such as a soda, and the like. The animal products can be any suitable animal product, such as cheese, milk, meat broth (such as beef broth, pork broth, chicken broth, turkey broth, duck broth, lamb broth, goat broth, rabbit broth, and the like), eggs, bone broth, bone marrow, meat (such as beef, pork, chicken, lamb, goat, turkey, duck, rabbit, and the like), butter, and animal skin.

In some embodiments, the ingestible composition comprises a non-animal protein, such as a plant protein, an algal protein, or a mycoprotein. In some embodiments, the ingestible composition comprises a plant protein. Non-limiting examples of such plant proteins include pea protein, soy protein, almond protein, cashew protein, canola (rapeseed) protein, chickpea protein, fava protein, sunflower protein, wheat protein, oat protein, and potato protein. In some embodiments, the ingestible composition comprises pea protein. In some embodiments, the ingestible composition comprises soy protein. The non-animal proteins can make up any suitable proportion of the ingestible composition. For example, in some embodiments, the non-animal protein makes up from 1 percent by weight to 99 percent by weight, or from 2 percent by weight to 90 percent by weight, or from 5 percent by weight to 80 percent by weight, or from 5 percent by weight to 70 percent by weight, or from 5 percent by weight to 60 percent by weight, or from 5 percent by weight to 50 percent by weight, of the ingestible composition, based on the total weight of the ingestible composition. In some embodiments, the ingestible composition comprises a non-animal protein (according to any of the above embodiments) and an animal protein, such as a dairy protein. The non-animal and animal proteins can be in any suitable form, such as protein concentrates, protein isolates, and the like.

In some embodiments, the ingestible composition comprises lipid materials, such as fats, oils, or any combinations thereof. Any suitable fats and oils can be used, such as non-animal fats and oils, including oils and fats derived from plants, algae, fungi, and the like. In some embodiments, the lipid material comprises vegetable fats or oils derived from various plants or seeds, such as olives, canola (rapeseed), peanuts, avocado, almond, hazelnut pecan, pumpkin, walnut, sunflower, safflower, corn, soybean, jatropha, grapeseed, cottonseed, palm, palm kernel, coconut, cocoa, sesame, hemp, mustard, rice bran, and the like. In some embodiments, the ingestible composition comprises coconut fat. Such fats or oils can be present in any suitable concentration within the ingestible composition. For example, in some embodiments, such fats or oils are present in the ingestible composition at a concentration ranging from 1 percent by weight to 25 percent by weight, or from 1 percent by weight to 20 percent by weight, or from 1 percent by weight to 15 percent by weight, or from 1 percent by weight to 12 percent by weight, or from 1 percent by weight to 10 percent by weight, or from 1 percent by weight to 7 percent by weight, or from 2 percent by weight to 5 percent by weight, based on the total weight of the ingestible composition.

In some embodiments, the ingestible composition comprises one or more soluble fibers. As used herein, the term “soluble fiber” refers to polysaccharides characterized as being soluble using the method of the Association of Official Analytical Chemists (AOAC) as set forth in Prosky et al., J. ASSOC. OFF. ANAL. CHEM., vol. 70(5), pp. 1017-1023 (1988). Any suitable soluble fibers can be used, including, but not limited to, fruit fibers (such as citrus fibers), grain fibers, psyllium husk fibers, other natural soluble fibers, and synthetic soluble fibers. Natural soluble fibers include, but are not limited to, soluble com fibers, maltodextrins, acacia fibers, and hydrolyzed guar gum. Synthetic soluble fibers include, but are not limited to, polydextrose, modified food starches, and the like. Non-limiting examples of food-grade sources of soluble fiber include, but are not limited to, inulin, corn fiber, barley fiber, com germ, ground oat hulls, milled corn bran, derivatives of the aleurone layer of wheat bran, flax flour, whole flaxseed bran, winter barley flake, ground course kilned oat groats, maize, pea fiber (e.g., Canadian yellow pea), Danish potatoes, konjac vegetable fiber (glucomannan), psyllium fiber from seed husks of planago ovate, psyllium husk, liquid agave fiber, rice bran, oat sprout fibers, amaranth sprout fiber, lentil flour, grape seed fiber, apple fiber, blueberry fiber, cranberry fiber, fig fiber, ciranda power, carob powder, milled prune fiber, mango fiber, orange fiber, orange pulp, strawberry fiber, carrageenan hydrocolloid, derivatives of eucheuma cottonnil seaweed, cottonseed fiber, soya fiber, kiwi fiber, acacia gum fiber, bamboo fiber, chia fiber, potato fiber, potato starch, pectin (carbohydrate) fiber, hydrolyzed guar gum, carrot fiber, chicory root fiber, oat fiber, wheat fiber, tomato fiber, polydextrose fiber, refined com starch syrup, isomalto-oligosaccharide mixtures, soluble dextrin, mixtures of citrus bioflavonoids, cell-wall broken nutritional yeast, lipophilic fiber, plum juice fiber, derivatives from larch trees, olygose fiber, derivatives from cane sugar, short-chain fructo-oligosaccharides, synthetic polymers of glucose, polydextrose, pectin, polyanionic compounds, cellulose fibers, cellulose fibers derived from hard wood plants, and carboxymethyl cellulose. Such insoluble fibers can be included in the ingestible composition in any suitable concentration. For example, in some embodiments, soluble fibers are present in the ingestible composition at a concentration ranging from 1 percent by weight to 25 percent by weight, or from 1 percent by weight to 20 percent by weight, or from 1 percent by weight to 15 percent by weight, or from 1 percent by weight to 12 percent by weight, or from 1 percent by weight to 10 percent by weight, or from 1 percent by weight to 7 percent by weight, or from 1 percent by weight to 5 percent by weight, based on the total weight of the ingestible composition.

In some embodiments, the ingestible composition comprises one or more insoluble fibers. Such insoluble fibers can provide structure and texture to the ingestible composition. Any suitable insoluble fibers can be used. In some embodiments, the insoluble fiber is a plant-derived fiber. Non-limiting examples include nut fibers, grain fibers, rice fibers, seed fibers, oat fibers, pea fibers, potato fibers, berry fibers, soybean fibers, banana fibers, citrus fibers, apple fibers, and carrot fibers. In some embodiments, the insoluble fiber is pea fiber. The insoluble fiber can make up any suitable proportion of the ingestible composition. For example, in some embodiments, the insoluble fiber makes up from 1 percent by weight to 50 percent by weight, or from 1 percent by weight to 40 percent by weight, or from 1 percent by weight to 30 percent by weight, or from 1 percent by weight to 20 percent by weight, of the ingestible composition, based on the total weight of the ingestible composition.

In some embodiments, the ingestible composition comprises one or more natural extracts to provide color, flavor, and the like. The term colorant includes FD&C colors, such as blue no. 1, blue no. 2, green no. 3, red no. 3, red no. 40, yellow no. 5, yellow no. 6, and the like. Natural colorants or coloring food stuff, such as caramel coloring, annatto, chlorophyllin, cochineal, betanin, turmeric, saffron, paprika, lycopene, elderberry juice, pandan, butterfly pea and the like, as well as titanium dioxide, carbon carbonate, or any suitable food colorant known to those of skill in the art. In some embodiments, the colorant is selected from bell pepper extract, beetroot extract, carrot extract, black current extract, malted barley powder, or any combination thereof. In some embodiments, the ingestible composition comprises beetroot extract. The beetroot extract can be used to provide a red color characteristic of uncooked red meat products.

In some embodiments, the ingestible compositions disclosed herein comprise a flavoring. In general, the flavoring improves the taste and flavor of the ingestible composition or the resulting flavored product in which the ingestible composition is used. Such improvement includes reducing the bitterness of the ingestible composition or the resulting flavored product, reducing the perception of astringency of the ingestible composition or the resulting flavored product, reducing the perception of green taste notes (such as pea taste) of the ingestible composition or the resulting flavored product, reducing the perception of cereal notes of the ingestible composition or the resulting flavored product, improving the perception of creaminess of the ingestible composition or the resulting flavored product, improving the perception of creaminess of the ingestible composition or the resulting flavored product, improving the perception of fattiness of the ingestible composition or the resulting flavored product, improving the perception of sweetness of the ingestible composition or the resulting flavored product, improving the perception of savory taste (umami or kokumi) of the ingestible composition or the resulting flavored product, improving the mouthfeel or mouthcoating of the ingestible composition or the resulting flavored product, improving the perception of juiciness of the ingestible composition or the resulting flavored product, improving the perception of thickness of the ingestible composition or the resulting flavored product, improving the vanillic character of the ingestible composition or the resulting flavored product, or any combination thereof.

Any suitable flavoring can be used. In some embodiments, the flavoring comprises synthetic flavor oils and flavoring aromatics or oils, oleoresins and extracts derived from plants, leaves, flowers, fruits, and so forth, or combinations thereof. Non-limiting examples of flavor oils include spearmint oil, cinnamon oil, oil of wintergreen (methyl salicylate), peppermint oil. Japanese mint oil, clove oil, bay oil, anise oil, eucalyptus oil, thyme oil, cedar leaf oil, oil of nutmeg, allspice, oil of sage, mace, oil of bitter almonds, and cassia oil. Non-limiting examples of other flavors include natural and synthetic fruit flavors such as vanilla, and citrus oils including lemon, orange, lime, grapefruit, vazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. In the context of dairy or dairy analog products, the most commonly used flavor agents are agents that impart flavors such as vanilla, French vanilla, chocolate, banana, lemon, hazelnut, coconut, almond, strawberry, mocha, coffee, tea, chai, cinnamon, caramel, cream, brown sugar, toffee, pecan, butter pecan, toffee, Irish creme, white chocolate, raspberry, pumpkin pie spice, peppermint, or any combination thereof.

In some embodiments, the flavoring is a meat flavoring, or other flavorings commonly used in the context of savory products. Such flavorings include glutamates, arginates, avocadene, avocadyne, a purine ribonucleitide (such as inosine monophosphate (IMP), guanosine monophosphate (GMP), hypoxanthine, inosine), a yeast extract, a fermented food product, cheese, garlic or extracts thereof, a gamma-glutamyl-containing polypeptide, a gamma-glutamyl-containing oligopeptide (such as gamma-glutamyl-containing tripeptides); an flavor-modifying composition (such as a cinnamic acid amide or a derivative thereof), a nucleotide, an oligonucleotide, a plant extract, a food extract, or any combinations thereof.

In some embodiments, the flavoring comprises a yeast extract, such as a yeast lysate. Such extracts can be obtained from any suitable yeast strain, where such extracts are suitable for human consumption. Non-limiting examples of such yeasts include: yeasts of the genus Saccharomyces, such as Saccharomyces cerevisiae or Saccharomyces pastorianus; yeasts of the genus Candida, such as Candida utilis; yeasts of the genus Kluyveromyces, such as Kluyveromyces lactis or Kluyveromyces marxianus; yeasts of the genus Pichia such as Pichia pastoris; yeasts of the genus Debaryomyces such as Debaryomyces hansenii; and yeasts of the genus Zygosaccharomyces such as Zygosaccharomyces mellis. In some embodiments, the yeast is a yeast collected after brewing beer, sake, or the like. In some embodiments, the yeast is a yeast subjected to drying treatment (dried yeast) after collection.

Such extracts can be produced by any suitable means. In general, yeast extracts or lysates are made by extracting the contents of the yeast cells from the cell wall material. In many instances, the digestive enzymes in the cells (or additional enzymes added to the composition) break down the proteins and polynucleotides in the yeast to amino acids, oligopeptides (for example, from 2 to 10 peptides), nucleotides, oligonucleotides (from 2 to 10 nucleotides), and mixtures thereof. A yeast lysate can be prepared by lysing a yeast. For example, in some embodiments, the yeast after culture is crushed or lysed by an enzymatic decomposition method, a self-digestion method, an alkaline extraction method, a hot water extraction method, an acid decomposition method, an ultrasonic crushing method, crushing with a homogenizer, a freezing-thawing method, or the like (two or more thereof may be used in combination), whereby a yeast lysate is obtained. Yeast may be cultured by a conventional method. In some embodiments, the yeast after culture is heat-treated and then treated with a lytic enzyme to obtain an enzyme lysate. The conditions for the heat treatment are, for example, 80° C. to 90° C. for 5 minutes to 30 minutes. As the lytic enzyme used for the enzymatic decomposition method, various enzymes can be used as long as they can lyse the cell wall of yeast. The reaction conditions may be set so as to be optimum or suitable for the lytic enzyme(s) to be used, and specific examples thereof can include a temperature of 50° C. to 60° C., and a pH of 7.0 to 8.0. The reaction time is also not particularly limited, and can be, for example, 3 hours to 5 hours.

Compositions comprising yeast lysate can be obtained from a variety of commercial sources. For example, in some embodiments, the yeast lysate is provides by the flavoring additive sold under the name MODUMAX (DSM Food Specialties BV, Delft, Netherlands).

In some embodiments, the flavoring comprises one or more flavor-modifying compounds, such as compounds that enhance sweetness (e.g., phloretin, naringenin, glucosylated steviol glycosides, etc.), compounds that block bitterness, compounds that enhance umami, compounds that enhance kokumi, compounds that reduce sourness or licorice taste, compounds that enhance saltiness, compounds that enhance a cooling effect, compounds that enhance mouthfeel, or any combinations of the foregoing.

Thus, in some embodiments, the flavoring comprises one or more sweetness enhancing compounds. Such sweetness enhancing compounds include, but are not limited to, naturally derived compounds, such as hesperitin dihydrochalcone, hesperitin dihydrochalcone-4′-O′glucoside, neohesperitin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, or synthetic compounds, such as any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1,6 bond, a β-1,2 bond, a β-1,4 bond, a β-1,6 bond, and so forth. In some embodiments of any of the preceding embodiments, the ingestible composition comprises 3-((4-amino-2,2-dioxo-1H-benzo[c][1,2,6]thiadiazin-5-yl)oxy)-2,2-dimethyl-N-propyl-propanamide or N-(1-((4-amino-2,2-dioxo-1H-benzo[c][1.2.6]thiadiazin-5-yl)oxy)-2-methyl-propan-2-yl)isonicotinamide. In some embodiments, the flavoring comprises rebaudioside A, rebaudioside D, or rebaudioside M as a sweetness enhancer.

In some further embodiments, the flavoring comprises one or more umami enhancing compounds. Such umami enhancing compounds include, but are not limited to, naturally derived compounds, or synthetic compounds, such as any compounds set forth in U.S. Pat. Nos. 8,735,081; 8,124,121; and 8,968,708. In some embodiments, the umami-enhancing compound is (2R,4R)-1,2,4-trihydroxy-heptadec-16-ene, (2R,4R)-1,2,4-trihydroxyheptadec-16-yne, or a mixture thereof. In some embodiments, the umami-enhancing compound is (3R,5S)-1-(4-hydroxy-3-methoxyphenyl)decane-3,5-diol diacetate. In some embodiments, the umami-enhancing compound is N-(heptan-4-yl)benzo[d][1,3]dioxole-5-carboxamide.

In some further embodiments, the flavoring comprises one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727.

In some further embodiments, the flavoring comprises one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759. In some embodiments, the bitterness blocking compound is 3-(1-((3,5-dimethylisoxazol-4-yl)-methyl)-1H-pyrazol-4-yl)-1-(3-hydroxybenzyl)-imidazolidine-2,4-dione.

In some further embodiments, the flavoring comprises one or more sour taste modulating compounds, such as acetic acid, citric acid, ascorbic acid, malonic acid, lactic acid, malic acid, and the like.

In some further embodiments, the flavoring comprises one or more mouthfeel modifying compounds. Such mouthfeel modifying compounds include, but are not limited to, tannins, cellulosic materials, bamboo powder, and the like.

In some further embodiments, the flavoring comprises one or more flavor masking compounds. Such flavor masking compounds include, but are not limited to, cellulosic materials, materials extracted from fungus, materials extracted from plants, citric acid, carbonic acid (or carbonates), and the like.

In some embodiments, the flavor-modifying compounds described above are included to improve other tastants that may be present in the ingestible composition itself, or that may be included within the flavored products that employ such compositions. Such tastants include sweeteners, umami tastants, kokumi tastants, bitter tastants, sour tastants, and the like.

For example, in some embodiments, the ingestible composition or the resulting flavored product comprises a sweetener. The sweetener can be present in any suitable concentration, depending on factors such as the sweetener's potency as a sweetener, its solubility, and the like. For example, in some embodiments, the sweetener is present in an amount ranging from 0.1 percent by weight to 12 percent by weight. This is particularly true when the sweetener is a carbohydrate sweetener, such as sucrose, fructose (including high-fructose com syrup, fruit juice, and the like), glucose, xylitol, erythritol, allulose, or any combinations thereof. In some other embodiments, the sweetener is present in an amount ranging from 10 ppm to 1000 ppm. Such lower concentrations may be more typical when the sweetener is a higher-potency sweetener such as a steviol glycoside (such as rebaudioside A, rebaudioside B, rebaudioside D, rebaudioside E, rebaudioside M, or any combination thereof), a mogroside (such as mogroside III, mogroside IV, mogroside V, siamenoside I, isomogroside V, mogroside IV_{E}, isomogroside IV, mogroside III_{E}, 1l-oxomogroside V, the 1,6-α isomer of siamenoside I, and any combinations thereof), a derivative of either of the foregoing, such as glycoside derivatives (e.g., glucosylates), cyclamate, aspartame, neotame, sucralose, acesulfame K, or any combinations thereof.

In general, the ingestible compositions can include any suitable sweeteners or combination of sweeteners. In some embodiments, the sweetener is a common saccharide sweeteners, such as sucrose, fructose, glucose, and sweetener compositions comprising natural sugars, such as com syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some other embodiments, the sweetener is agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum. Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populfolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bemadame, canderel, carrelame and other guanidine-based sweeteners, vegetable fiber, com sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falemum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In some embodiments, the ingestible composition comprises a bitter tastant, such as any compound that agonizes one or more T2R taste receptors. Such bitter tastants include potassium chloride, caffeine, plant proteins, vitamins, minerals, caffeine, and the like. In some embodiments, the ingestible composition comprises one or more umami or kokumi tastants. Such tastants include glutamates, arginates, avocadene, avocadyne, a purine ribonucleitide (such as inosine monophosphate (IMP), guanosine monophosphate (GMP), hypoxanthine, inosine), a yeast extract (as described in further detail above), a fermented food product, cheese, garlic or extracts thereof, a gamma-glutamyl-containing polypeptide, a gamma-glutamyl-containing oligopeptide (such as gamma-glutamyl-containing tripeptides); an flavor-modifying composition (such as a cinnamic acid amide or a derivative thereof), a nucleotide, an oligonucleotide, a plant extract, a food extract, sodium chloride, any salt substitute, and the like.

In some embodiments, the ingestible composition comprises an emulsifier, such as a non-hydrocolloid emulsifier. Any suitable non-hydrocolloid emulsifier can be used. For example, in some non-limiting embodiments, the emulsifier comprises lecithin, monoglycerides, diglycerides, polysorbates, vegetable oils, and the like. In some embodiments, the emulsifier comprises lecithin. The emulsifier can be present in any suitable concentration, which can be adjusted so as to form a stable emulsion of the other components in the ingestible composition, for example, when incorporated into a flavored product.

In some embodiments, it may be desirable to include additives that assist in adjusting the viscosity of the ingestible composition. Various salts and acids can be used to carry out such adjustments. In some embodiments, the ingestible composition comprises one or more salts. Non-limiting examples of suitable salts include magnesium sulfate, sodium chloride, sodium sulfate, calcium chloride, calcium sulfate, potassium sulfate, potassium chloride, potassium sorbate, potassium phosphate, potassium monophosphate, zinc chloride, zinc sulfate, or any mixtures thereof. In some embodiments, the ingestible composition also comprises one or more acids, which may be used alone or in combination with the aforementioned salts. Non-limiting examples of suitable acids include citric acid, lactic acid, acetic acid, tartaric acid, succinic acid, ascorbic acid, maleic acid, phosphoric acid, monopotassium phosphate, gluconic acid, glucono-lactone, glucoronic acid, glycyrrhetic acid, folic acid, pantothenic acid or mixtures thereof.

In some embodiments, the ingestible composition includes one or more fortification compounds. Such fortification compounds include, but are not limited to, vitamins, minerals, and iron salts. Non-limiting examples of vitamins include vitamins A, vitamin B complexes (including one or more of vitamin B-1, vitamin B-2, vitamin B-6, and vitamin B-12), vitamin C, vitamin D, vitamin E, vitamin K, niacin, and acid vitamins such as pantothenic acid, folic acid, and biotin. Non-limiting examples of minerals include calcium, iron, zinc, magnesium, iodine, copper, phosphorus, manganese, potassium, chromium, molybdenum, selenium, nickel, tin, silicon, and vanadium. In some embodiments, the mineral is an iron salt, such as ferric sodium EDTA, reduced iron, ferrous lactate, ferric citrate, ferric pyrophosphate, ferrous sulphate monohydrate, or ferric ammonium citrate brown. Specific amounts of fortification compounds will depend on a variety of factors such as the identity of other components of the ingestible composition, and the like.

In some embodiments, the ingestible composition comprises one or more fillers. In some embodiments, the filler is a carbohydrate. Suitable carbohydrates include, but are not limited to, starches, flours, sugars, maltodextrins, glucose syrups, or any combinations thereof. Such starches or flours include those from plants such as rice, wheat, corn, barley, and sorghum, potato, cassava, sweet potato, arrowroot, yam, pea, chickpea, mung bean, or lentil, or any combination thereof. When present, such fillers can have any suitable concentration in the ingestible composition. For example, in some embodiments, the ingestible composition comprises fillers at a concentration ranging from 0.1 percent by weight to 10 percent by weight, or from 0.5 percent by weight to 10 percent by weight, or from 1 percent by weight to 10 percent by weight, based on the total weight of the ingestible composition.

The ingestible compositions disclosed herein can, in certain embodiments, contain other additives, adjuvants, and the like, that are commonly included in food products, pet food products, and feed products. For example, the ingestible compositions disclosed herein can, in certain embodiments, comprise any additional ingredients or combination of ingredients as are commonly used in comestible products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi); coloring agents, including, for example caramel color, Red #40. Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, Panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;
clouding agents, including, for example ester gun, brominated vegetable oil (BVO), or sucrose acetate isobutyrate (SAIB);
buffers, including, for example sodium citrate, potassium citrate, or salt;
flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or
starches and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), inulin, or carrageenan.

The ingestible composition can have any suitable pH. In some embodiments. TM1, or a comestibly acceptable salt thereof, enhances the umami taste of an umami tastant over a broad range of pH, e.g., from lower pH to neutral pH. The lower and neutral pH includes, but is not limited to, a pH from 1.5 to 9.0, or from 2.5 to 8.5; from 3.0 to 8.0; from 3.5 to 7.5; and from 4.0 to 7. In certain embodiments, compounds as disclosed and described herein, individually or in combination, can enhance the perceived sweetness of a fixed concentration of a sweetener in taste tests at a compound concentration of 50 μM, 40 μM, 30 μM, 20 μM, or 10 μM at both low to neutral pH value. In certain embodiments, the enhancement factor of the compounds as disclosed and described herein, individually or in combination, at the lower pH is substantially similar to the enhancement factor of the compounds at neutral pH. Such consistent sweet enhancing property under a broad range of pH allow a broad use in a wide variety of foods and beverages of the compounds as disclosed and described herein, individually or in combination.

### Flavored Products

In certain aspects, the disclosure provides a flavored product comprising an ingestible composition of any preceding aspect of embodiment thereof, or any of the ingestible compositions formed by the use or method of any of the preceding aspects of embodiments thereof. In some embodiments, the flavored product is a food product, such as a soup, a packaged casserole mix, a chip or crisp, a cracker, a cookie, a biscuit, a meat product (such as a sausage), a meat analogue product (such as a vegan chicken nugget or tender, a vegan chicken filet, a vegan burger, a vegan beef cutlet, a vegan sausage, and the like), or a dairy analogue product (such as vegan yogurt). In some other embodiments, the ingestible composition is a beverage product, such as a carbonated beverage, a dairy analogue product, a hard seltzer, and the like.

In embodiments where the flavored product is a beverage, the beverage may be selected from the group consisting of enhanced sparkling beverages, colas, lemon-lime flavored sparkling beverages, orange flavored sparkling beverages, grape flavored sparkling beverages, strawberry flavored sparkling beverages, pineapple flavored sparkling beverages, ginger-ales, root beers, fruit juices, fruit-flavored juices, juice drinks, nectars, vegetable juices, vegetable-flavored juices, sports drinks, energy drinks, enhanced water drinks, enhanced water with vitamins, near water drinks, coconut waters, tea type drinks, coffees, cocoa drinks, beverages containing milk components, beverages containing cereal extracts and smoothies. In some embodiments, the beverage is a soft drink. In some embodiments, the beverage is a vegan dairy product, such as a vegan smoothie.

Further non-limiting examples of food and beverage products include ingredients for such products or any entity included in the Soup category, the Dried Processed Food category, the Beverage category, the Ready Meal category, the Canned or Preserved Food category, the Frozen Processed Food category, the Chilled Processed Food category, the Snack Food category, the Baked Goods category, the Confectionery category, the Dairy Product category, the Ice Cream category, the Meal Replacement category, the Pasta and Noodle category, and the Sauces, Dressings, Condiments category, the Baby Food category, and/or the Spreads category.

In general, the Soup category refers to canned/preserved, dehydrated, instant, chilled, UHT and frozen soup. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).

The Dehydrated and Culinary Food Category usually means: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.

The Beverage category usually means beverages, beverage mixes and concentrates, including but not limited to, carbonated and non-carbonated beverages, alcoholic and non-alcoholic beverages, ready to drink beverages, liquid concentrate formulations for preparing beverages such as sodas, and dry powdered beverage precursor mixes. The Beverage category also includes the alcoholic drinks, the soft drinks, sports drinks, isotonic beverages, and hot drinks. The alcoholic drinks include, but are not limited to beer, cider/perry, FABs, wine, and spirits. The soft drinks include, but are not limited to carbonates, such as colas and non-cola carbonates; fruit juice, such as juice, nectars, juice drinks and fruit flavored drinks; bottled water, which includes sparkling water, spring water and purified/table water; functional drinks, which can be carbonated or still and include sport, energy or elixir drinks; concentrates, such as liquid and powder concentrates in ready to drink measure. The drinks, either hot or cold, include, but are not limited to coffee or ice coffee, such as fresh, instant, and combined coffee; tea or ice tea, such as black, green, white, oolong, and flavored tea; and other drinks including flavor-, malt- or plant-based powders, granules, blocks or tablets mixed with milk or water.

The Snack Food category generally refers to any food that can be a light informal meal including, but not limited to Sweet and savory snacks and snack bars. Examples of snack food include, but are not limited to fruit snacks, chips/crisps, extruded snacks, tortilla/corn chips, popcorn, pretzels, nuts and other sweet and savory snacks. Examples of snack bars include, but are not limited to granola/muesli bars, breakfast bars, energy bars, fruit bars and other snack bars.

The Baked Goods category generally refers to any edible product the process of preparing which involves exposure to heat or excessive sunlight. Examples of baked goods include, but are not limited to bread, buns, cookies, muffins, cereal, toaster pastries, pastries, waffles, tortillas, biscuits, pies, bagels, tarts, quiches, cake, any baked foods, and any combination thereof.

The Ice Cream category generally refers to frozen dessert containing cream and sugar and flavoring. Examples of ice cream include, but are not limited to: impulse ice cream; take-home ice cream; frozen yoghurt and artisanal ice cream; soy, oat, bean (e.g., red bean and mung bean), and rice-based ice creams.

The Confectionery category generally refers to edible product that is sweet to the taste. Examples of confectionery include, but are not limited to candies, gelatins, chocolate confectionery, sugar confectionery, gum, and the likes and any combination products.

The Meal Replacement category generally refers to any food intended to replace the normal meals, particularly for people having health or fitness concerns. Examples of meal replacement include, but are not limited to slimming products and convalescence products.

The Ready Meal category generally refers to any food that can be served as meal without extensive preparation or processing. The ready meal includes products that have had recipe “skills” added to them by the manufacturer, resulting in a high degree of readiness, completion and convenience. Examples of ready meal include, but are not limited to canned/preserved, frozen, dried, chilled ready meals; dinner mixes; frozen pizza; chilled pizza; and prepared salads.

The Pasta and Noodle category includes any pastas and/or noodles including, but not limited to canned, dried and chilled/fresh pasta; and plain, instant, chilled, frozen and snack noodles.

The Canned/Preserved Food category includes, but is not limited to canned/preserved meat and meat products, fish/seafood, vegetables, tomatoes, beans, fruit, ready meals, soup, pasta, and other canned/preserved foods.

The Frozen Processed Food category includes, but is not limited to frozen processed red meat, processed poultry, processed fish/seafood, processed vegetables, meat substitutes, processed potatoes, bakery products, desserts, ready meals, pizza, soup, noodles, and other frozen food.

The Dried Processed Food category includes, but is not limited to rice, dessert mixes, dried ready meals, dehydrated soup, instant soup, dried pasta, plain noodles, and instant noodles. The Chill Processed Food category includes, but is not limited to chilled processed meats, processed fish/seafood products, lunch kits, fresh cut fruits, ready meals, pizza, prepared salads, soup, fresh pasta and noodles.

The Sauces, Dressings and Condiments category includes, but is not limited to tomato pastes and purees, bouillon/stock cubes, herbs and spices, monosodium glutamate (MSG), table sauces, soy based sauces, pasta sauces, wet/cooking sauces, dry sauces/powder mixes, ketchup, mayonnaise, mustard, salad dressings, vinaigrettes, dips, pickled products, and other sauces, dressings and condiments.

The Baby Food category includes, but is not limited to milk- or soybean-based formula; and prepared, dried and other baby food.

The Spreads category includes, but is not limited to jams and preserves, honey, chocolate spreads, nut based spreads, and yeast based spreads.

The Dairy Product category generally refers to edible product produced from mammal's milk. Examples of dairy product include, but are not limited to drinking milk products, cheese, yoghurt and sour milk drinks, and other dairy products.

Additional examples for flavored products, particularly food and beverage products are provided as follows. In some embodiments, the food products include confectioneries, chocolate confectionery, tablets, countlines, bagged selflines/softlines, boxed assortments, standard boxed assortments, twist wrapped miniatures, seasonal chocolate, chocolate with toys, alfajores, other chocolate confectionery, mints, standard mints, power mints, boiled sweets, pastilles, gums, jellies and chews, toffees, caramels and nougat, medicated confectionery, lollipops, liquorice, other sugar confectionery, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes, breakfast cereals, rte cereals, family breakfast cereals, flakes, muesli, other cereals, children's breakfast cereals, hot cereals, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavored, functional and other condensed milk, flavored milk drinks, dairy only flavored milk drinks, flavored milk drinks with fruit juice, soy milk, sour milk drinks, fermented dairy drinks, coffee whiteners, powder milk, flavored powder milk drinks, cream, cheese, processed cheese, spreadable processed cheese, unspreadable processed cheese, unprocessed cheese, spreadable unprocessed cheese, hard cheese, packaged hard cheese, unpackaged hard cheese, yoghurt, plain/natural yoghurt, flavored yoghurt, fruited yoghurt, probiotic yoghurt, drinking yoghurt, regular drinking yoghurt, probiotic drinking yoghurt, chilled and shelf-stable desserts, dairy-based desserts, soy-based desserts, chilled snacks, fromage frais and quark, plain fromage frais and quark, flavored fromage frais and quark, savory fromage frais and quark, sweet and savory snacks, fruit snacks, chips/crisps, extruded snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, frozen pizza, chilled pizza, soup, canned soup, dehydrated soup, instant soup, chilled soup, hot soup, frozen soup, pasta, canned pasta, dried pasta, chilled/fresh pasta, noodles, plain noodles, instant noodles, cups/bowl instant noodles, pouch instant noodles, chilled noodles, snack noodles, canned food, canned meat and meat products, canned fish/seafood, canned vegetables, canned tomatoes, canned beans, canned fruit, canned ready meals, canned soup, canned pasta, other canned foods, frozen food, frozen processed red meat, frozen processed poultry, frozen processed fish/seafood, frozen processed vegetables, frozen meat substitutes, frozen potatoes, oven baked potato chips, other oven baked potato products, non-oven frozen potatoes, frozen bakery products, frozen desserts, frozen ready meals, frozen pizza, frozen soup, frozen noodles, other frozen food, dried food, dessert mixes, dried ready meals, dehydrated soup, instant soup, dried pasta, plain noodles, instant noodles, cups/bowl instant noodles, pouch instant noodles, chilled food, chilled processed meats, chilled fish/seafood products, chilled processed fish, chilled coated fish, chilled smoked fish, chilled lunch kit, chilled ready meals, chilled pizza, chilled soup, chilled/fresh pasta, chilled noodles, oils and fats, olive oil, vegetable and seed oil, cooking fats, butter, margarine, spreadable oils and fats, functional spreadable oils and fats, sauces, dressings and condiments, tomato pastes and purees, bouillon/stock cubes, stock cubes, gravy granules, liquid stocks and fonds, herbs and spices, fermented sauces, soy based sauces, pasta sauces, wet sauces, dry sauces/powder mixes, ketchup, mayonnaise, regular mayonnaise, mustard, salad dressings, regular salad dressings, low fat salad dressings, vinaigrettes, dips, pickled products, other sauces, dressings and condiments, baby food, milk formula, standard milk formula, follow-on milk formula, toddler milk formula, hypoallergenic milk formula, prepared baby food, dried baby food, other baby food, spreads, jams and preserves, honey, chocolate spreads, nut-based spreads, and yeast-based spreads. Exemplary ingestible compositions also include confectioneries, bakery products, ice creams, dairy products, sweet and savory snacks, snack bars, meal replacement products, ready meals, soups, pastas, noodles, canned foods, frozen foods, dried foods, chilled foods, oils and fats, baby foods, or spreads or a mixture thereof. Exemplary ingestible compositions also include breakfast cereals, sweet beverages or solid or liquid concentrate compositions for preparing beverages, ideally so as to enable the reduction in concentration of previously known saccharide sweeteners, or artificial sweeteners.

Some embodiments provide a chewable composition that may or may not be intended to be swallowed. In some embodiments, the chewable composition may be gum, chewing gum, sugarized gum, sugar-free gum, functional gum, bubble gum including compounds as disclosed and described herein, individually or in combination.

In some embodiments, the ingestible compositions set forth above may be provided in a flavoring concentrate formulation, e.g., suitable for subsequent processing to produce a ready-to-use (i.e., ready-to-serve) product. By “a flavoring concentrate formulation”, it is meant a formulation which should be reconstituted with one or more diluting medium to become a ready-to-use composition. The term “ready-to-use composition” is used herein interchangeably with “ingestible composition”, which denotes any substance that, either alone or together with another substance, can be taken by mouth whether intended for consumption or not. In one embodiment, the ready-to-use composition includes a composition that can be directly consumed by a human or animal. The flavoring concentrate formulation is typically used by mixing with or diluted by one or more diluting medium, e.g., any consumable or ingestible ingredient or product, to impart or modify one or more flavors to the diluting medium. Such a use process is often referred to as reconstitution. The reconstitution can be conducted in a household setting or an industrial setting. For example, a frozen fruit juice concentrate can be reconstituted with water or other aqueous medium by a consumer in a kitchen to obtain the ready-to-use fruit juice beverage. In another example, a soft drink syrup concentrate can be reconstituted with water or other aqueous medium by a manufacturer in large industrial scales to produce the ready-to-use soft drinks. Since the flavoring concentrate formulation has the flavoring agent or flavor modifying agent in a concentration higher than the ready-to-use composition, the flavoring concentrate formulation is typically not suitable for being consumed directly without reconstitution. There are many benefits of using and producing a flavoring concentrate formulation. For example, one benefit is the reduction in weight and volume for transportation as the flavoring concentrate formulation can be reconstituted at the time of usage by the addition of suitable solvent, solid or liquid.

In one embodiment, the flavoring concentrate formulation or ingestible composition comprises TM1 or a comestibly acceptable salt thereof, a carrier, and, optionally, at least one adjuvant. The term “carrier” denotes a usually inactive accessory substance, such as solvents, binders, or other inert medium, which is used in combination with the present compound and one or more optional adjuvants to form the formulation. For example, water or starch can be a carrier for a flavoring concentrate formulation. In some embodiments, the carrier is the same as the diluting medium for reconstituting the flavoring concentrate formulation; and in other embodiments, the carrier is different from the diluting medium. The term “carrier” as used herein includes, but is not limited to, ingestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more sweeteners. The one or more sweeteners can be any of the sweeteners described in this application. In another embodiment, the at least one adjuvant comprises one or more ingredients selected from the group consisting of a emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

In one embodiment, the present flavoring concentrate formulation can be in a form selected from the group consisting of liquid including solution and suspension, solid, foamy material, paste, gel, cream, and a combination thereof, such as a liquid containing certain amount of solid contents. In one embodiment, the flavoring concentrate formulation is in form of a liquid including aqueous-based and nonaqueous-based. In some embodiments, the present flavoring concentrate formulation can be carbonated or non-carbonated.

The flavoring concentrate formulation may further comprise a freezing point depressant, nucleating agent, or both as the at least one adjuvant. The freezing point depressant is an ingestibly acceptable compound or agent which can depress the freezing point of a liquid or solvent to which the compound or agent is added. That is, a liquid or solution containing the freezing point depressant has a lower freezing point than the liquid or solvent without the freezing point depressant. In addition to depress the onset freezing point, the freezing point depressant may also lower the water activity of the flavoring concentrate formulation. The examples of the freezing point depressant include, but are not limited to, carbohydrates, oils, ethyl alcohol, polyol, e.g., glycerol, and combinations thereof. The nucleating agent denotes an ingestibly acceptable compound or agent which is able to facilitate nucleation. The presence of nucleating agent in the flavoring concentrate formulation can improve the mouthfeel of the frozen Blushes of a frozen slush and to help maintain the physical properties and performance of the slush at freezing temperatures by increasing the number of desirable ice crystallization centers. Examples of nucleating agents include, but are not limited to, calcium silicate, calcium carbonate, titanium dioxide, and combinations thereof.

In one embodiment, the flavoring concentrate formulation is formulated to have a low water activity for extended shelf life. Water activity is the ratio of the vapor pressure of water in a formulation to the vapor pressure of pure water at the same temperature. In one embodiment, the flavoring concentrate formulation has a water activity of less than about 0.85. In another embodiment, the flavoring concentrate formulation has a water activity of less than about 0.80. In another embodiment, the flavoring concentrate formulation has a water activity of less than about 0.75.

In one embodiment, the flavoring concentrate formulation has the present compound in a concentration that is at least 2 times of the concentration of the compound in a ready-to-use composition. In one embodiment, the flavoring concentrate formulation has the present compound in a concentration that is at least 5 times of the concentration of the compound in a ready-to-use composition. In one embodiment, the flavoring concentrate formulation has the present compound in a concentration that is at least 10 times of the concentration of the compound in a ready-to-use composition. In one embodiment, the flavoring concentrate formulation has the present compound in a concentration that is at least 15 times of the concentration of the compound in a ready-to-use composition. In one embodiment, the flavoring concentrate formulation has the present compound in a concentration that is at least 20 times of the concentration of the compound in a ready-to-use composition. In one embodiment, the flavoring concentrate formulation has the present compound in a concentration that is at least 30 times of the concentration of the compound in a ready-to-use composition. In one embodiment, the flavoring concentrate formulation has the present compound in a concentration that is at least 40 times of the concentration of the compound in a ready-to-use composition. In one embodiment, the flavoring concentrate formulation has the present compound in a concentration that is at least 50 times of the concentration of the compound in a ready-to-use composition. In one embodiment, the flavoring concentrate formulation has the present compound in a concentration that is at least 60 times of the concentration of the compound in a ready-to-use composition. In one embodiment, the flavoring concentrate formulation has the present compound in a concentration that is up to 100 times of the concentration of the compound in a ready-to-use composition.

In some embodiments, the flavorings may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

Suitable bulking agents include, but are not limited to maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and the like, and mixtures thereof. Additionally, granulated sugar (sucrose) or other caloric sweeteners such as crystalline fructose, other carbohydrates, or sugar alcohols can be used as a bulking agent due to their provision of good content uniformity without the addition of significant calories.

In one embodiment, the bulking agent may be a bulking agent described in U.S. Pat. No. 8,993,027. In one embodiment, the bulking agent may be a bulking agent described in U.S. Pat. No. 6,607,771. In one embodiment, the bulking agent may be a bulking agent described in U.S. Pat. No. 6,932,982.

In some embodiments, the flavored product may further comprise at least one anti-caking agent. As used herein the phrase “anti-caking agent” and “flow agent” refer to any composition which prevents, reduces, inhibits, or suppresses the at least one sweetener from attaching, binding, or contacting to another sweetener molecule. Alternatively, anti-caking agent may refer to any composition which assists in content uniformity and uniform dissolution. Non-limiting examples of anti-caking agents include cream of tartar, calcium silicate, silicon dioxide, microcrystalline cellulose (Avicel, FMC BioPolymer, Philadelphia, Pa.), and tricalcium phosphate. In one embodiment, the anti-caking agents are present in the tabletop sweetener composition in an amount from about 0.001 to about 3% by weight of the tabletop sweetener composition.

### Non-Animal Protein Materials and Products Made Therefrom

Products intended to replace or substitute meat or dairy products often rely on various non-animal-based materials, such as starches and proteins derived from plants, algae, fungi, or combinations thereof, to simulate the texture and flavor of meat or dairy. Non-limiting examples of non-animal-based proteins are plant proteins, such as soy proteins, pea proteins, bean proteins, grain proteins, and the like. Due to compositional differences between such plant-based materials and animal-derived materials, these proteins can impart a bitter taste.

Thus, in certain aspects, the disclosure provides a flavored product comprising a plant-based material (such as a plant-based starch, a plant-based protein, or a combination thereof) and TM1 or a comestibly acceptable salt thereof. In some embodiments, the flavored product comprises TM1 or a comestibly acceptable salt thereof, and a plant protein, such as pea protein, soy protein, potato protein, or any combination thereof. In some further embodiments, the flavored product can include any features of combination of features set forth above for ingestible compositions that contain TMT or a comestibly acceptable salt thereof. In some embodiments, the flavored product is a beverage, such as soy milk, almond milk, rice milk, oat milk, a protein drink, a meal-replacement drink, or other like product. In some other embodiments, the flavored product is a meat-replacement product, such as a plant-based chicken product (such as a plant-based chicken nugget), a plant-based beef product (such as a plant-based burger), and the like. In some other embodiments, the flavored product is a protein powder, a meal-replacement powder, a plant-based creamer for coffee or tea, and the like. In certain further embodiments, any such products contain additional ingredients, and have additional features, as are typically used in the preparation and/or manufacture of such products. For example, such TM1 or comestibly acceptable salts thereof, may be combined with other flavors and taste modifiers, and may even be encapsulated in certain materials, according to known technologies in the relevant art. Suitable concentrations of TM1 or comestibly acceptable salts thereof, are set forth above.

In some embodiments, the flavored products comprise one or more plant-based proteins, which impart a bitter taste that is at least partially reduced by the use of TM1 in the product. Such plant-based proteins include, but are not limited to, pea protein, soy protein, canola (rapeseed) protein, potato protein, chickpea protein, mycoproteins, algal proteins, fava protein, sunflower protein, wheat protein, and the like.

In some alternative embodiments analogous to the above embodiments, algal or fungal proteins or starches are used instead, oat protein, potato protein, and the like. In some embodiments, these flavored products also include fiber to provide texture to the product. Fibers suitable for use include, but are not limited to, psyllium fiber, pea fiber, potato fiber, curdlan, soluble corn fiber (dextran and/or maltodextrin), citrus fiber, and combinations thereof. In such products. TM1 can be introduced in any suitable way. In some embodiments, TM1 is incorporated into a flavoring emulsion, such as a water-in-oil emulsion, along with other flavor-imparting ingredients.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described, and claimed herein. The reader will recognize that the skilled artisan, armed with the present disclosure, and skill in the art is able to prepare and use the invention without exhaustive examples.

### Example 1—Umami Enhancement of MSG

A series of test samples and a comparative sample were prepared. The comparative sample (C) contained 0.3 wt % sodium chloride and 0.05 wt % MSG. Two test samples were prepared. Each test sample contained sodium chloride and MSG in the same amounts as the comparative sample plus 2 ppm of TM1 (sample S1) or 5 ppm of TM1 (sample S2). Panelists were asked to rate the intensity of certain sensory features of the samples on a scale of 0 to 10. Higher numbers indicate greater intensity. Table 1 shows the mean results. An asterisk nest to the result for S1 or S2 indicated that the difference from C is statistically significant.

TABLE 1

| | Sample C | Sample S1 | Sample S2 |
|---|---|---|---|
| Saltiness Intensity | 3.6 | 3.8 | 3.8 |
| Umami Intensity | 4.0 | 4.8 | 6.0* |
| Lasting Umami Intensity | 3.1 | 4.2* | 5.4* |
| Overall Liking | 3.6 | 4.8* | 6.0* |

### Example 2—Flavor Modification of Chicken Broth

A series of test samples and a comparative sample were prepared. The comparative sample (C) was a standard reconstituted chicken broth solution containing 0.7 wt % sodium chloride and 0.04 wt % MSG. Two test samples were prepared. Each test sample contained chicken broth, sodium chloride, and MSG in the same amounts as the comparative sample plus 3 ppm of TM1 (sample S1) or 5 ppm of TM1 (sample S2). Panelists were asked to rate the intensity of certain sensory features of the samples on a scale of 0 to 10. Higher numbers indicate greater intensity. Table 2 shows the mean results. An asterisk nest to the result for S1 or S2 indicated that the difference from C is statistically significant.

TABLE 2

| | Sample C | Sample S1 | Sample S2 |
|---|---|---|---|
| Saltiness Intensity | 4.9 | 5.2 | 4.8 |
| Umami Intensity | 4.3 | 5.8* | 6.2* |
| Lasting Umami Intensity | 3.1 | 4.2* | 5.4* |
| Chicken Flavor Intensity | 5.3 | 6.0* | 5.8 |
| White Meat Intensity | 4.8 | 5.8* | 4.8 |
| Overall Liking | 5.0 | 6.2* | 7.0* |

### Example 3—MSG Reduction with Crisp

A test sample and a comparative sample were prepared. The comparative (sample C) was a standard potato crisp having 2 wt % flavoring (sour cream and onion), 0.03 wt % MSG, and 0.008 wt % purinic ribonucleotide. This reflects a 75% reduction of the standard amount of MSG used in such products (0.12 wt %). The test sample contained flavoring, MSG, and purinic ribonucleotide in the same amounts as the comparative sample plus 5 ppm of TM1 (sample S1). Panelists were asked to rate the intensity of certain sensory features of the samples on a scale of 0 to 10. Higher numbers indicate greater intensity. Table 3 shows the mean results. An asterisk nest to the result for S indicated that the difference from C is statistically significant.

TABLE 3

| | Sample C | Sample S1 |
|---|---|---|
| Saltiness Intensity | 2.9 | 3.1 |
| Umami Intensity | 3.0 | 3.6* |
| Lasting Umami Intensity | 2.1 | 2.8* |
| Sour Intensity | 2.1 | 2.9* |
| Overall Liking | 3.3 | 4.0* |

### Example 4—MSG Reduction with Vegan Chicken Nugget

A test sample and a comparative sample were prepared. The comparative (sample C) was a standard soy-based vegan chicken nugget having 1.68 wt % flavoring (chicken), 0.4 wt % MSG, and 0.03 wt % purinic ribonucleotide. The test sample contained flavoring, MSG, and purinic ribonucleotide in the same amounts as the comparative sample plus 5 ppm of TM1 (sample S1). Panelists were asked to rate the intensity of certain sensory features of the samples on a scale of 0 to 10. Higher numbers indicate greater intensity. Table 4 shows the mean results. An asterisk nest to the result for S indicated that the difference from C is statistically significant.

TABLE 4

| | Sample C | Sample S1 |
|---|---|---|
| Saltiness Intensity | 4.6 | 4.4 |
| Umami Intensity | 5.1 | 5.8* |

1. Use of a flavor-modifying compound to enhance an umami taste of an ingestible composition, wherein the flavor-modifying compound is a compound of formula (I) 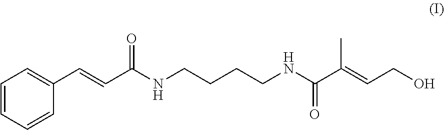 [SMILES: C/C(=C\CO)C(=O)NCCCCNC(=O)/C=C/c1ccccc1]
or a comestibly acceptable salt thereof; and
wherein the flavor-modifying compound enhances the umami taste of the ingestible composition without enhancing a salty taste of the ingestible composition.

2. The use of claim 1, wherein the ingestible composition comprises an umami tastant.

3. The use of claim 2, wherein the umami tastant is a glutamate, a purinic ribonucleotide, a yeast extract, or any combination thereof.

4. The use of claim 3, wherein the umami tastant is a purinic ribonucleotide, a yeast extract, or any combination thereof.

5. The use of any one of claims 1 to 4, wherein the ingestible composition comprises a non-animal protein.

6. The use of claim 5, wherein the non-animal protein is pea protein, soy protein, potato protein, chickpea protein, a bean protein, sunflower protein, or any combination thereof.

7. A method of enhancing an umami taste of an ingestible composition, the method comprising introducing a flavor-modifying compound to the ingestible composition, wherein the flavor-modifying compound is a compound of formula (I) 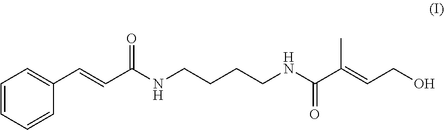 [SMILES: C/C(=C\CO)C(=O)NCCCCNC(=O)/C=C/c1ccccc1]
or a comestibly acceptable salt thereof; and
wherein the flavor-modifying compound enhances the umami taste of the ingestible composition without enhancing a salty taste of the ingestible composition.

8. The method of claim 7, wherein the ingestible composition comprises an umami tastant.

9. The method of claim 8, wherein the umami tastant is a glutamate, a purinic ribonucleotide, a yeast extract, or any combination thereof.

10. The method of claim 9, wherein the umami tastant is a purinic ribonucleotide, a yeast extract, or any combination thereof.

11. The method of any one of claims 7 to 10, wherein the ingestible composition comprises a non-animal protein.

12. The method of claim 11, wherein the non-animal protein is pea protein, soy protein, potato protein, chickpea protein, a bean protein, sunflower protein, or any combination thereof.

13. An ingestible composition comprising an umami tastant and a flavor-modifying compound, wherein the flavor-modifying compound is a compound of formula (I) 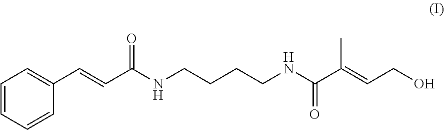 [SMILES: C/C(=C\CO)C(=O)NCCCCNC(=O)/C=C/c1ccccc1]
or a comestibly acceptable salt thereof;
wherein the concentration of the flavor-modifying compound in the ingestible composition ranges from 0.1 ppm to 500 ppm, based on the total weight of the ingestible composition; and
wherein the umami tastant is a purinic ribonucleotide, a yeast extract, or any combination thereof.

14. The ingestible composition of claim 13, further comprising a glutamate.

15. A flavored product, which comprises an ingestible composition of claim 13 or 14.
